(19) United States
(12) Patent Application Publication
(10) Pub. No.: US 2025/0196695 A1
(43) Pub. Date: Jun. 19, 2025

(54) CONTROL DEVICE AND CONTROL METHOD

(71) Applicant: TOYOTA JIDOSHA KABUSHIKI KAISHA, Toyota-shi (JP)

(72) Inventors: Takahiro MISAWA, Okazaki-shi (JP); Takahiro UEKI, Toyota-shi (JP)

(73) Assignee: TOYOTA JIDOSHA KABUSHIKI KAISHA, Toyota-shi (JP)

(21) Appl. No.: 18/899,028

(22) Filed: Sep. 27, 2024

(30) Foreign Application Priority Data
Dec. 19, 2023 (JP) 2023-213729

(51) Int. Cl. B60L 53/66; H02J 7/00

(52) U.S. Cl. CPC B60L 53/665; H02J 7/00032

(57) ABSTRACT

A battery information server (control device) includes a communication unit that transmits information of a root certificate to an EVSE when requesting a contract certificate from an EVSE (power stand), and a processor. The processor changes the root certificate if the communication unit receives an inconsistency notification indicating that the root certificate does not match EVSE. The communication unit transmits the changed root certificate to EVSE.

### CROSS-REFERENCE TO RELATED APPLICATION

This application claims priority to Japanese Patent Application No. 2023-213729 filed on Dec. 19, 2023, incorporated herein by reference in its entirety.

### BACKGROUND

### 1. Technical Field

The present disclosure relates to a control device and a control method.

### 2. Description of Related Art

WO 2021/158021 discloses a battery electric vehicle that can be charged by a PnC system from a charging station. When a contract certificate is stored (installed) in the battery electric vehicle, the above-described PnC charge can be achieved.

### SUMMARY

Here, although not explicitly described in the above-mentioned WO 2021/158021, information regarding a root certificate needs to be transmitted from the battery electric vehicle to the charging station in order to store (install) the contract certificate in the battery electric vehicle (vehicle). However, a syntactic pattern (rule) of the root certificate corresponding to the battery electric vehicle has not been defined by standards. Therefore, the root certificate may not match between the battery electric vehicle and the charging station. In such cases, the contract certificate cannot be installed in the battery electric vehicle. Therefore, it is not possible to perform charging by PnC system between the battery electric vehicle and the charging station. Therefore, charge control (power transmission) by the PnC system may not be established between the battery electric vehicle and the charging station.

The present disclosure provides a control device and a control method capable of reducing a failure of power transmission between an electrified vehicle and a power stand due to mismatch of a root certificate corresponding to the electrified vehicle with the power stand.

A control device according to a first aspect of the present disclosure is a control device for a vehicle that communicates with a power stand being able to perform power transmission including at least one of charging and discharging, the control device including:
a communication unit that transmits information regarding a root certificate to the power stand to acquire (request) a contract certificate; and
a processor.
   The processor changes the root certificate when the communication unit receives a mismatch notification indicating that the root certificate does not match the power stand.
   The communication unit transmits information regarding the changed root certificate to the power stand. Note that the root certificate indicates a certificate of a root Certificate Authority (CA), which is a digital certificate certification authority, itself created by the root CA signing the certificate.

The control device according to the first aspect of the present disclosure changes the root certificate and transmits the information regarding the changed root certificate to the power stand when the communication unit receives the mismatch information indicating that the root certificate does not match the power stand as described above. It is thus possible to request (request again) the contract certificate using the changed root certificate even when the root certificate does not match the power stand. As a result, it is possible to reduce a failure of power transmission to or from the power stand as compared with a case where the contract certificate cannot be requested again. Therefore, it is possible to reduce the failure of the power transmission between an electrified vehicle and the power stand due to mismatch of the root certificate corresponding to the electrified vehicle with the power stand.

In the control device according to the first aspect, the communication unit may transmit the information regarding the changed root certification to the power stand without transmitting information regarding the root certificate before the change to the power stand for the next power transmission to or from the power stand when the changed root certificate is determined to match the power stand. With such a configuration, it is possible to omit the transmission of information regarding the root certificate that does not match the power stand and to transmit the information regarding the root certificate that has successfully matched the power stand to the power stand. As a result, it is possible to shorten the time required for the root certificate to be determined to match the power stand in the next power transmission.

In this case, the control device may include a storage unit that stores the root certificate that matches the power stand in association with the power stand.

When the communication unit receives a match notification indicating that the changed root certificate matches the power stand, (i) the processor may update the information in the storage unit, and (ii) the communication unit may transmit the information regarding the changed root certificate based on the updated information in the storage unit to the power stand without transmitting the information regarding the root certificate before the change to the power stand for the next power transmission to or from the power stand. With such a configuration, the information can be acquired without using communication with an external device unlike a case where information regarding the root certificate and the power stand that match each other is stored in the external device. As a result, it is possible to reduce a processing load on the control device.

In the control device according to the first aspect, the power stand may be configured to be able to charge the vehicle based on each of a Plug and Charge (PnC) charging method and an External Identification Means (EIM) charging method.

The processor may
repeatedly change the root certificate until the changed root certificate matches the power stand for execution of charging based on the PnC charging method, and
switch a charging method from the PnC charging method to the EIM charging method when the number of times the root certificate has been changed reaches a predetermined number of times. With such a configuration, it is possible to give up executing the PnC charging method and to move on to a charge sequence based on the EIM charging method when a charge sequence based on the PnC charging method is not appropriately started even after the root certificate is changed a predetermined number of times. As a result, it is possible to quickly start the charging as compared with a case where the change of the root certificate is further continued.

A control method according to a second aspect of the present disclosure is a control method performed by a control device for a vehicle that communicates with a power stand being able to perform power transmission including at least one of charging and discharging, the control method including:
firstly transmitting information regarding a root certificate to the power stand to acquire a contract certificate;
receiving a mismatch notification indicating that the root certificate does not match the power stand after the firstly transmitting;
changing the root certificate after the receiving; and
secondly transmitting information regarding the root certificate changed in the changing to the power stand.

In the control method according to the second aspect of the present disclosure, the communication unit receives a mismatch notification indicating that the root certificate does not match the power stand as described above. In this case, the root certificate is changed, and the information regarding the changed root certificate is transmitted to the power stand. Accordingly, it is possible to provide a control method capable of reducing a failure of power transmission between an electrified vehicle and the power stand due to the mismatch of the root certificate corresponding to electrified vehicle with the power stand.

According to the present disclosure, it is possible to reduce a failure of power transmission between the electrified vehicle and the power stand due to the mismatch of the root certificate corresponding to the electrified vehicle with the power stand.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a charging system according to an embodiment;

FIG. 2 is a diagram illustrating a configuration of a root certificate; and

FIG. 3 is a sequence diagram illustrating control in a charging system according to an embodiment.

### DETAILED DESCRIPTION OF EMBODIMENTS

Hereinafter, an embodiment of the present disclosure will be described in detail with reference to the drawings. The same or corresponding parts in the drawings are designated by the same reference signs and repetitive description will be omitted.

### Configuration of the Charging System

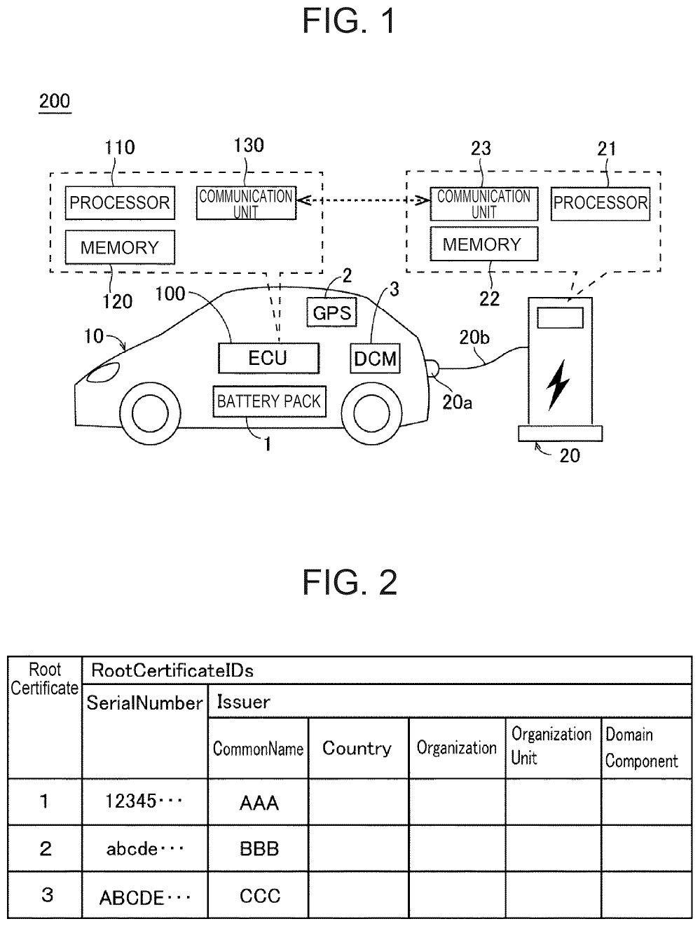

FIG. 1 is a diagram illustrating a configuration of a charging system 200 according to the present embodiment. The charging system 200 includes an electrified vehicle 10 including an ECU 100 and an Electric Vehicle Supply Equipment (EVSE) 20. Note that electrified vehicle 10 and EVSE 20 are exemplary “vehicles” and “power stands” of the present disclosure, respectively. In addition, ECU 100 is an exemplary “control device” of the present disclosure.

Electrified vehicle 10 include, for example, a Plug-in Hybrid Electric Vehicle (PHEV), a Battery Electric Vehicle (BEV), or a Fuel Cell Electric Vehicle (FCEV).

EVSE 20 means a vehicular power supply facility. Electrified vehicle 10 is configured to be electrically connectable to EVSE 20. EVSE 20 includes a cable 20b to which the connector 20a is attached. When the connector 20a is connected to an inlet (not shown) of electrified vehicle 10, electric power is supplied (charged) from EVSE 20 to the electrified vehicle 10. Charging is an example of “power transmission” of the present disclosure.

EVSE 20 is configured to be able to charge electrified vehicle based on each of Plug and Charge (PnC) charging method and External Identification Means (EIM) charging method. PnC charging method refers to a charging method in which an EVSE 20 connector 20a is simply connected to an electrified vehicle 10, and processes such as billing authentication and charging are automatically executed. EIM charging method refers to a charging method in which a user of an electrified vehicle 10 uses cash, electronic money, or the like to pay at an installation location of an EVSE 20 or an EVSE 20 body.

Electrified vehicle 10 includes an Electric Control Unit (ECU) 100 and a battery pack 1. Electrified vehicle 10 includes a Global Positioning System (GPS) module 2 and a Data Communication Module (DCM) 3.

The battery pack 1 stores, for example, electric power used for traveling of electrified vehicle 10. The charge from EVSE 20 allows the storage capacity of the battery pack 1 to be increased.

GPS module 2 receives GPS signals transmitted from three or more (preferably four or more) satellites over electrified vehicle 10 and locates the position of electrified vehicle 10. The position of electrified vehicle 10 determined by GPS module 2 is transmitted to DCM 3 by CAN communication or the like. Note that GPS module 2 may be built in a car navigation device (not shown) or the like.

DCM 3 is configured to be accessible to external communication servers, the Internet, and the like. As a result, electrified vehicle 10 can acquire various types of data from the outside through DCM 3.

ECU 100 transmits and receives data to and from the above-described battery pack 1, GPS module 2, DCM 3, and the like by CAN communication or the like by the communication unit 130, which will be described later. ECU 100 is configured to control the above-described devices.

ECU 100 includes a processor 110, a memory 120, and a communication unit 130. The memory 120 stores a program to be executed by the processor 110 and information (for example, a map, a mathematical expression, and various parameters) used in the program. Note that the memory 120 is an example of a “storage unit” of the present disclosure.

The memory 120 stores the root certificate illustrated in FIG. 2. In the example illustrated in FIG. 2, three of the root certificates 1 to 3 are stored in the memory 120. The root certificate refers to a certificate that is created by the root CA, which is a certificate authority of the digital certificate, and is signed by itself.

The memory 120 stores root certificates consistent with EVSE 20 in association with EVSE 20. When it is determined that the root certificate matches EVSE 20, the processor 110 stores the root certificate and EVSE 20 in the memory 120 in association with each other (updates the information in the memory 120).

The communication unit 130 transmits the root certificate to EVSE 20 in order to acquire (request) the contract certificate. When the processor 110 obtains the contract certificate through EVSE 20, it creates a list of root certificates based on the profile of the root certificate stored in the memory 120. For example, the processor 110 may create a listing of at least one of “Serial Number”, “Common Name”, “Country”, “Organization”, “Organization Unit”, and “Domain Component” based on the profile of the root certificate. Then, the processor 110 transmits the created list to EVSE 20 through the communication unit 130. In the following description, a pattern of an item in which information is set is referred to as a “syntax pattern”.

When the connector 20a is connected to electrified vehicle 10, the communication unit 130 transmits and receives information to and from EVSE 20 (the communication unit 23 described later) through the cable 20b.

EVSE 20 includes a processor 21, a memory 22, and a communication unit 23. In the memory 22, information (for example, a map, a mathematical expression, and various parameters) used in the program is stored in addition to the program executed by the processor 21.

Here, in order to store (install) the contract certificate in electrified vehicle, the root certificate needs to be transmitted from electrified vehicle to EVSE. However, the syntactic pattern (rule) of the root certificate corresponding to electrified vehicle is not defined by the standard. Therefore, the root certificate may not match between electrified vehicle and EVSE. In this case, the contract certificate in electrified vehicle cannot be installed, and PnC system cannot be charged between electrified vehicle and EVSE. Therefore, the charge control by PnC charging method between electrified vehicle and EVSE may not be established.

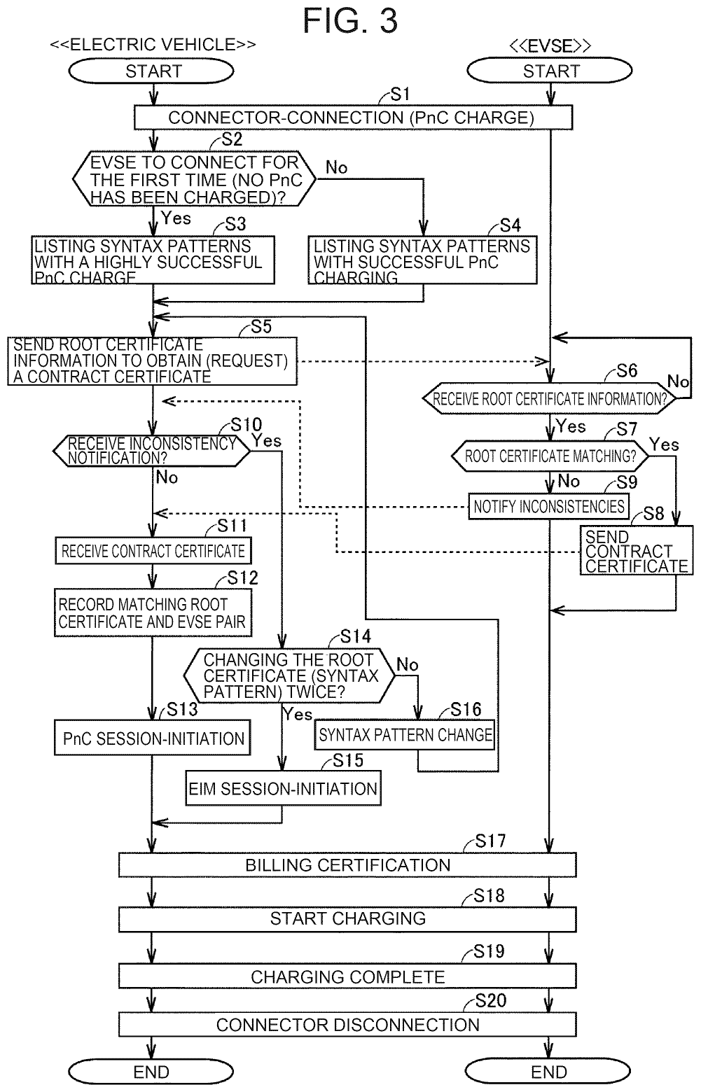

Therefore, in the present embodiment, the processor 110 changes the root certificate when the communication unit 130 receives the inconsistency notification indicating that the root certificate does not match EVSE 20. Specifically, the processor 110 changes the root certificate by changing an item in which information is set in the root certificate. Then, the communication unit 130 transmits the changed root certificate to EVSE 20. Details will be described with reference to FIG. 3.

### Sequence Control of Charging System

FIG. 3 is a diagram illustrating sequential control (S2 to S19 described later) corresponding to the control methods performed by the charging system 200. The respective processes of electrified vehicle 10 illustrated in FIG. 3 are executed by an ECU 100 (processor 110). The respective processes of EVSE 20 are executed by the processor 21.

In S1, the connector 20a of EVSE 20 is connected to electrified vehicle 10. As a result, electrified vehicle 10 can be charged PnC.

In S2, electrified vehicle 10 determines in S1 whether the connected EVSE 20 is EVSE to be connected to electrified vehicle 10 for the first time. Electrified vehicle 10 performs the above determination based on, for example, the charge history information (the position information on which PnC charge has been performed, ID information on EVSE in which PnC charge has been performed, or the like) stored in the memory 120. If it is connected to EVSE 20 for the first time (Yes in S2), the process proceeds to S3. If it has been previously connected to EVSE 20 (No in S2), the process proceeds to S4. Note that the term “connected to EVSE 20 in the past” means that PnC charging has been performed with the EVSE 20 in the past. Also, connecting to EVSE 20 for the first time means that there is no track record of PnC charge with EVSE 20.

In S3, electrified vehicle 10 creates a listing based on a syntactic pattern that has a good track record of PnC charge in EVSE installed in respective regions. The above-described track record is stored in, for example, an external server (not shown) capable of communicating with DCM 3.

In S4, electrified vehicle 10 creates a syntax-pattern-based listing in which EVSE 20 has historically been successful in PnC charge. The above-described historical results are stored in the memory 120 of the electrified vehicle 10. The above-described historical results may be stored in an external server (not shown) capable of communicating with DCM 3. Note that there may be a plurality of syntax patterns having a success track record. In this case, a syntax pattern may be randomly selected from a plurality of syntax patterns having a success track record, or a syntax pattern having the highest priority based on a predetermined condition (for example, in descending order of the number of items to be set) may be selected.

In S5, electrified vehicle 10 transmits the root certificate based on the list created in S3 or S4 to EVSE 20 through the communication unit 130 in order to obtain (request) the contract certificate. For example, assume that information of a root certificate based on a syntax pattern in which information is set in two items of “Serial Number” and “Common Name” illustrated in FIG. 2 is transmitted to an EVSE 20.

In S6, EVSE 20 determines whether the root certificate sent from electrified vehicle 10 in S5 has been received. If the root certificate is received (Yes in S6), the process proceeds to S7. If the root certificate is not received (No in S6), S7 process is repeated.

In S7, EVSE 20 determines, based on the information received in S6, whether the root certificate corresponding to electrified vehicle 10 matches EVSE 20 (itself). If the root certificate matches EVSE 20 (Yes in S7), the process proceeds to S8. If the root certificate does not match EVSE 20 (No in S7), the process proceeds to S9.

In S8, EVSE 20 transmits a contract certificate issued from a Public Key Infrastructure (PKI) provider to electrified vehicle 10 through the communication unit 23.

In S9, EVSE 20 transmits, through the communication unit 23, a message indicating that the root certificate based on the information received in S6 does not match EVSE 20 to electrified vehicle 10.

In S10, electrified vehicle 10 determines whether an inconsistency notification of S9 has been received. If no inconsistency notification has been received (No in S10), the process proceeds to S11. If an inconsistency notification has been received (Yes in S10), the process proceeds to S14.

In S11, electrified vehicle 10 receives the subscription certificate sent from EVSE 20 in S8.

In S12, a set of the root certificate and EVSE 20 that are matched to each other (a set of the root certificate and EVSE 20 of S5) is recorded in the memory 120 (information of the memory 120 is updated).

In S13, electrified vehicle 10 initiates a charging session (PnC session) based on PnC charging method.

In S14, electrified vehicle 10 determines whether or not the number of times of change of the root certificate (syntax pattern) has reached two. If the number of root certificate changes has reached two (Yes in S14), the process proceeds to S15. If the number of root certificate changes is less than two (No in S14), the process proceeds to S16.

In S15, electrified vehicle 10 abandons PnC charge and initiates a charge session (EIM session) based on EIM charging method. The process then proceeds to S17.

In S16, electrified vehicle 10 changes the root certificate syntax pattern. For example, electrified vehicle 10 changes the syntactic pattern by incrementing the item in which the information is set by one (e.g., adding the information to the item corresponding to “Country”). Note that the method of changing the syntax pattern is not limited to the above example. The process then returns to S5. That is, in S5, the syntax pattern of the modified root certificate is sent to EVSE 20.

In S7 after the process returns to S5, it is determined that the root certificate whose syntax pattern has been changed matches EVSE 20. Electrified vehicle 10 then receives S8 subscription certificate in S11 (corresponding to the “receipt of the consistency notification” disclosed herein). In this instance, electrified vehicle 10 (processor 110) updates S12 120 so that the syntax-pattern-modified root certificate and EVSE 20 are associated with each other. Electrified vehicle 10 (communication unit 130) transmits the information of the changed root certificate based on the updated information of the memory 120 to EVSE 20 without transmitting the information of the changed root certificate to EVSE 20 at the time of the next charge with EVSE 20 (next S4).

In S17, billing authorization is performed between electrified vehicle 10 and EVSE 20. In S18, the charge between electrified vehicle 10 and EVSE 20 is started. In S19, the charge ends. In S20, the connector 20a of EVSE 20 is disconnected from electrified vehicle 10.

As described above, in the present embodiment, the processor 110 changes the root certificate when the communication unit 130 receives the inconsistency notification indicating that the root certificate does not match EVSE 20. The communication unit 130 transmits the changed root certificate to EVSE 20. Thus, even if the root certificate does not match EVSE 20, the root certificate can be changed to attempt to reconnect PnC charge. As a consequence, it is possible to reduce PnC charge from being completed due to failure (shifting to EIM charge).

In the above-described embodiment, the control for changing the root certificate is executed at the time of charge control of electrified vehicle 10. Control may be performed to change the root certificate during the discharging control of electrified vehicle 10. In addition, control for changing the root certificate may be performed both at the time of charge control and at the time of discharge control of electrified vehicle 10.

In the above embodiment, when it is determined that the changed root certificate matches EVSE 20, the information of the changed root certificate is transmitted to EVSE 20 without the information of the previous root certificate being transmitted to EVSE 20 in the next charge in EVSE 20. However, the present disclosure is not limited to this example. Electrified vehicle may first send the pre-change root certificate (the default root certificate) to EVSE 20, regardless of the determination in the previous charge.

In the above-described embodiment, when the number of times of change of the root certificate reaches a predetermined number of times (two times in the above-described embodiment), switching to EIM session is performed. When the number of times of changing the root certificate reaches a predetermined number of times, the charge control itself may be terminated.

In the above-described embodiment, EIM session is switched when the number of times of change of the root certificate reaches two. The upper limit of the number of times of changing the root certificate may be a number other than two. For example, electrified vehicle 10 may be able to change the root certificate until all items of the syntax pattern shown in FIG. 2 have been informed. A specific description will be given. It is assumed that electrified vehicle 10 can increment the items (see FIG. 2) for which the information is set by one when the root certificate is changed. For example, electrified vehicle 10 changes the root certificate by setting Country from the status of FIG. 2. Therefore, electrified vehicle 10 can add data to the items “Country”, “Organization”, “Organization Unit”, and “Domain Component” from the status of FIG. 2. Thus, electrified vehicle 10 can change the root certificate four times. The method of changing the root certificate is not limited to the above example.

In the above embodiment, the determination of the consistency between the root certificate and EVSE 20 is performed by EVSE 20, but the present disclosure is not limited thereto. For example, the determination may be performed by external servers that differ from EVSE 20. In addition, the determination result (inconsistency notification and consistency notification) may be transmitted from the external servers to electrified vehicle 10.

In the above-described embodiment, it is determined whether or not electrified vehicle 10 and EVSE 20 are connected for the first time after the connector 20a is connected. For example, in response to EVSE 20 being searched by the car navigation system, it may be determined whether electrified vehicle 10 is connected to EVSE 20 for the first time. Alternatively, it may be determined whether or not electrified vehicle 10 is connected to EVSE 20 for the first time in response to electrified vehicle 10 stopping in the vicinity of EVSE 20.

In the above embodiment, the information of the root certificate (list of syntax patterns) to be sent to EVSE 20 first is adjusted depending on whether or not electrified vehicle 10 is connected to EVSE 20 for the first time (see S3 and S4 in FIG. 3). However, the present disclosure is not limited to this example. Regardless of whether electrified vehicle 10 is connected to EVSE 20 for the first time or not, the information of the root certificate that is first sent to EVSE 20 may be constant (e.g., the information of the default root certificate).

Note that the control of the above-described embodiment and the above-described various modification examples may be performed in combination with each other.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A control device for a vehicle that communicates with a power stand being able to perform power transmission including at least one of charging and discharging, the control device comprising:
a communication unit that transmits information regarding a root certificate to the power stand to acquire a contract certificate; and
a processor, wherein:
the processor changes the root certificate when the communication unit receives a mismatch notification indicating that the root certificate does not match the power stand; and
the communication unit transmits information regarding the changed root certificate to the power stand.

2. The control device according to claim 1, wherein the communication unit transmits the information regarding the changed root certification to the power stand without transmitting information regarding the root certificate before the change to the power stand for the next power transmission to or from the power stand when the changed root certificate is determined to match the power stand.

3. The control device according to claim 2, further comprising a storage unit that stores the root certificate that matches the power stand in association with the power stand, wherein when the communication unit receives a match notification indicating that the changed root certificate matches the power stand,
the processor updates information in the storage unit, and
the communication unit transmits information regarding the changed root certificate based on the updated information in the storage unit to the power stand without transmitting information regarding the root certificate before the change to the power stand for the next power transmission to or from the power stand.

4. The control device according to claim 1, wherein:
the power stand is configured to be able to charge the vehicle based on each of a Plug and Charge charging method and an External Identification Means charging method; and
the processor
repeatedly changes the root certificate until the changed root certificate matches the power stand for execution of charging based on the Plug and Charge charging method, and
switches a charging method from the Plug and Charge charging method to the External Identification Means charging method when the number of times the root certificate has been changed reaches a predetermined number of times.

5. A control method performed by a control device for a vehicle that communicates with a power stand being able to perform power transmission including at least one of charging and discharging, the control method comprising:
firstly transmitting information regarding a root certificate to the power stand to acquire a contract certificate;
receiving a mismatch notification indicating that the root certificate does not match the power stand after the firstly transmitting;
changing the root certificate after the receiving; and
secondly transmitting information regarding the root certificate changed in the changing to the power stand.
